(19) United States
(12) Patent Application Publication
(10) Pub. No.: US 2017/0038032 A1
(43) Pub. Date: Feb. 9, 2017

(54) LIGHT WITH DYNAMIC LIGHT PATTERN

(71) Applicant: TSAN-YAO CHEN, TAIPEI (TW)

(72) Inventor: TSAN-YAO CHEN, TAIPEI (TW)

(21) Appl. No.: 14/820,074

(22) Filed: Aug. 6, 2015

(51) Int. Cl. F21V 14/02; F21V 33/00

(52) U.S. Cl. CPC F21V 14/02; F21V 33/0056; F21Y 2101/02

(57) ABSTRACT

A light with dynamic light patterns is revealed. The light includes a still cylindrical/or conical outer pattern layer, an inner pattern layer driven by a rotary disc, and a lighting unit mounted inside the inner patter layer. The inner pattern layer has a diameter smaller than that of the outer pattern layer so as to be disposed close to an inner surface of the outer pattern layer. Moreover, the inner and the outer pattern layers are arranged with patterns that match each other well respectively such as patterns with effect of persistence of vision. Light emitted from the lighting unit firstly passes the rotated inner pattern layer and the still outer pattern layer to be projected to an outer sleeve when the inner pattern layer is rotated clockwise or counterclockwise. Thus dynamic light patterns are displayed.

### BACKGROUND OF THE INVENTION

The present invention relates to a light, especially to light with dynamic light patterns, which is driven by a motor or combine d with an audio unit.

While purchasing a light device or a light combined with a speaker of an audio unit, consumers should note varieties and diversities of light patterns besides the function of emitting light or playing sounds. There are already some light combined with the audio unit available now. For example, a plurality of light emitting diode (LED) lights is disposed in a speaker cabinet. Light emitted from LED lights is passed through at least one display surface on the speaker cabinet such as a transparent or translucent surface to be displayed. The LED lights are controlled by a control circuit to be flashing along with sounds the speaker played. Thus a specific light pattern is provided and decorative effect of the light/or the speaker is improved. However, the light pattern displayed is boring and dull due to limitations of internal structure. The market competitiveness of the light or the speaker is lowered.

### SUMMARY OF THE INVENTION

Therefore it is a primary object of the present invention to provide a light with dynamic light patterns with higher market competitiveness. The light includes a still cylindrical/or conical outer pattern layer, an inner pattern layer driven by a rotary disc, and a lighting unit set inside the inner patter layer. The inner pattern layer has a diameter smaller than that of the outer pattern layer so as to be disposed close to an inner surface of the outer pattern layer. The inner pattern layer and the outer pattern layer are arranged with patterns that match each other well such as patterns with persistence of vision effect respectively. When the inner pattern layer is driven to rotate clockwise or counterclockwise, light emitted from the lighting unit firstly passes the rotated inner pattern layer and the still outer pattern layer to be projected to a transparent or translucent outer sleeve. Thus dynamic light patterns are displayed on an outer surface of the outer sleeve. The light can also be used as a speaker cabinet.

In order to achieve the above object, a light with dynamic light patterns according to the present invention mainly includes a housing, a lighting unit, a mounting member, a gear set, a motor, a rotary disc, a circuit board unit and a pattern layer set. The pattern layer set consists of a still outer pattern layer and an inner pattern layer close to the outer pattern layer. The inner pattern layer is disposed on and rotated along with the rotary disc. The inner and the outer pattern layers are arranged with patterns that match each other well such as patterns with effect of persistence of vision. Light emitted from the lighting unit passes the rotated inner pattern layer and the still outer pattern layer to be projected to a transparent or translucent outer sleeve when the inner pattern layer is driven to rotate clockwise or counterclockwise. Thus users can see dynamic light patterns shown on the outer sleeve.

### BRIEF DESCRIPTION OF THE DRAWINGS

FIG. 1 is a perspective view showing a front side of an embodiment (a vertical cylindrical type) according to the present invention;

FIG. 2 is a perspective view showing a rear side of the embodiment in FIG. 1;

FIG. 3 is a front view of the embodiment in FIG. 1;

FIG. 4 is an explosive of the embodiment in FIG. 1;

FIG. 5 is a top view of a first cap having a mounting member, a gear set, and a motor therein of the embodiment in FIG. 4;

FIG. 6 is a bottom view of a rotary disc of the embodiment in FIG. 4;

FIG. 7 is a front view of a pattern of an extended outer pattern layer of an embodiment according to the present invention;

FIG. 8 is a front view of a pattern of an extended inner pattern layer used in combination with the outer pattern layer of the embodiment in FIG. 7 according to the present invention;

FIG. 9 is a schematic drawing showing a dynamic light pattern formed by the patterns in FIG. 7 and FIG. 8 at a first time point according to the present invention;

FIG. 10 is a schematic drawing showing a dynamic light pattern at a second time point later than the first time point according to the present invention;

FIG. 11 is a front view of a pattern of an extended inner pattern layer according to the present invention;

FIG. 12 is a perspective view of another embodiment (horizontal cylindrical type) according to the present invention;

FIG. 13 is a front view of the embodiment in FIG. 12 according to the present invention;

FIG. 14 is an explosive view of the embodiment in FIG. 12 according to the present invention;

FIG. 15 is a perspective view of a further embodiment (vertical conical type) according to the present invention;

FIG. 16 is a front view of the embodiment in FIG. 15 according to the present invention;

FIG. 17 is an explosive view of the embodiment in FIG. 15 according to the present invention.

### DETAILED DESCRIPTION OF THE PREFFERED EMBODIMENT

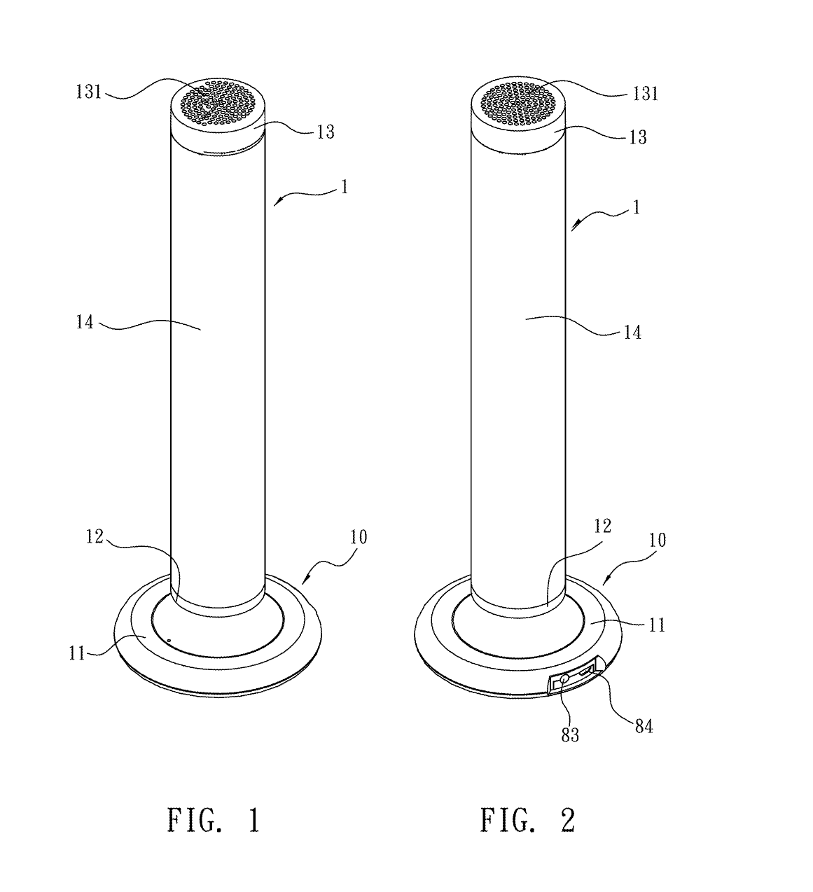

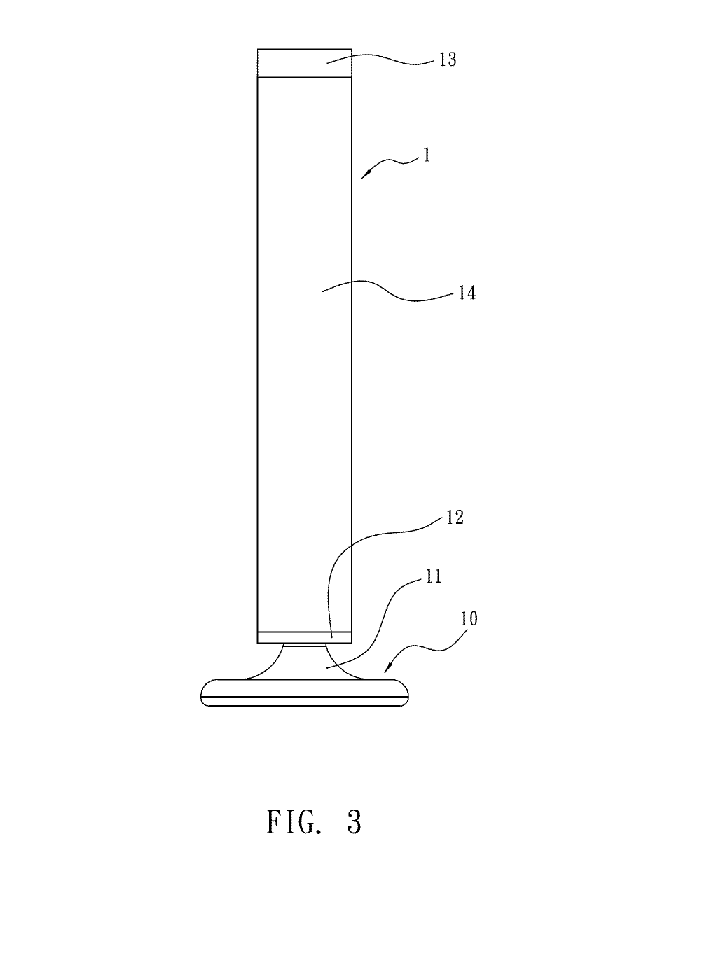

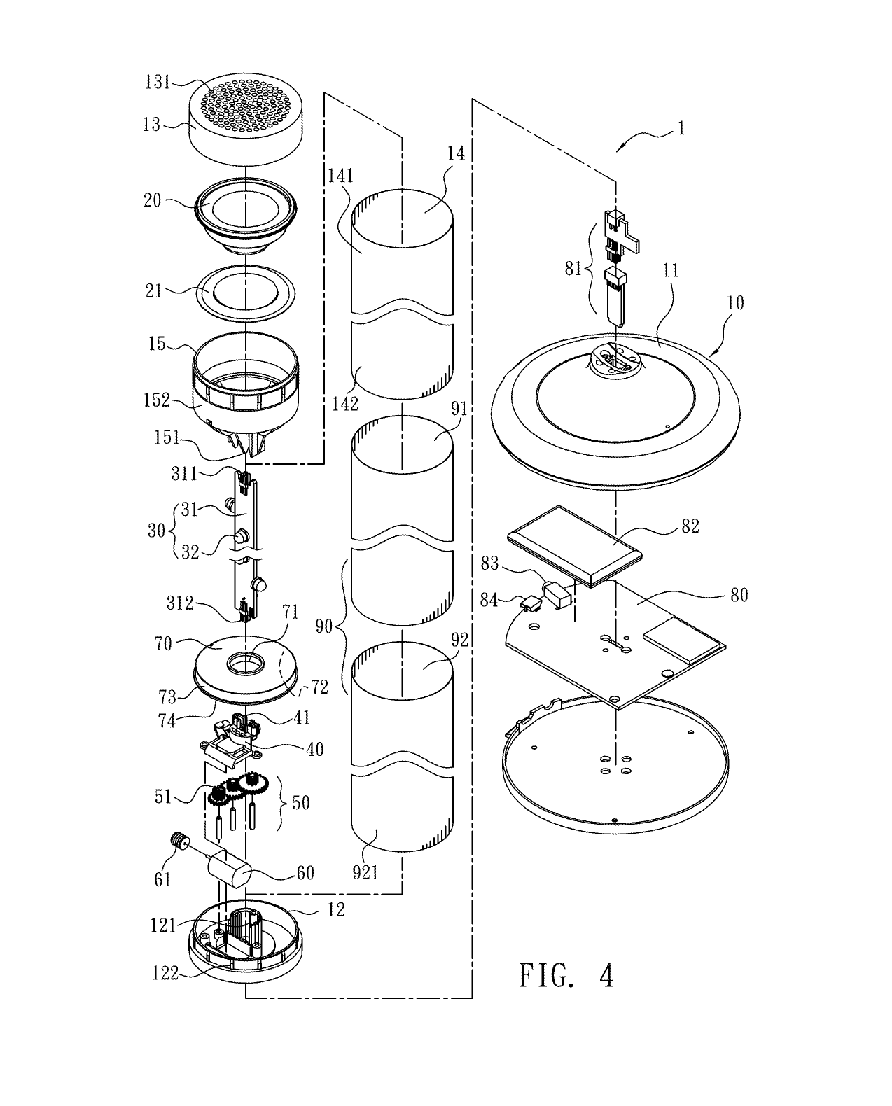

Refer from FIG. 1 to FIG. 6, a first embodiment of the present invention is a vertical cylindrical light 1. Refer to FIG. 4, the light 1 of the present invention further includes an audio unit 20. The audio unit 20 is an optional accessory of the present invention. The light 1 of the present invention includes a housing 10, an audio unit 20, a lighting unit 30, a mounting member 40, a gear set 50, a motor 60, a rotary disc 70, a circuit board unit 80 and a cylindrical pattern layer set 90. The above components are drawn to scale.

In this embodiment, the housing 10 consists of a base 11, a first cap 12, a second cap 13, an outer sleeve 14, and a receiving member 15. The base 11 is used for standing on a plan surface such as a desk surface. A space inside the base 11 is used to mount the circuit board unit 80 and the related components such as a power supply unit 82, a power port 83 or a control port 84 such as USB port. The first cap 12 is connected to and disposed over the base 11 while a space therein is arranged with a mounting bracket 121 used for loading the mounting member 40, the gear set 50, and the motor 60. The mounting member 40, the gear set 50, and the motor 60 in the mounting bracket 121 are electrically connected to the circuit board unit 80 in the base 11. The second cap 13 is disposed on the end opposite to the first cap 12. The translucent outer sleeve 14 is an optional component of the present invention and is fixed between the first cap 12 and the second cap 13 to form one part. In this embodiment, the outer sleeve 14 is a transparent or semi-transparent cylindrical tube made from plastic materials. The receiving member 15 is set under the second cap 13 while a space inside the receiving member 15 is used to mount the audio unit 20 and the related components such as a speaker mounting member 21. Take the embodiment shown in FIG. 1-4 as an example, the first cap 12 and the second cap 13 become a lower cap and an upper cap of the outer sleeve 14 respectively. While being assembled, a lower end 142 of the outer sleeve 14 is fitted over an upper outer-edge surface 122 of the first cap 12 while an upper end 141 is disposed around a lower outer-edge surface 152 of the receiving member 15 under the second cap 13. Thus the outer sleeve 14 is fixed.

The audio unit 20 and/or related components such as the speaker mounting member 21 are mounted between the second cap 13 and the receiving member 15. The audio unit 20 is electrically connected to the lighting unit 30 by an electrical socket 151 on the bottom end of the receiving member 15. Thereby the audio unit 20 gets power to make sounds such as music. The sounds are played through a plurality of through holes 131 on the second cap 13.

The lighting unit 30 is composed of a long strip 31 disposed with circuit and a plurality of light emitting elements 32 such as light emitting diode distributed over the long strip 31 and used for emitting light out. For convenient assembly, an upper end 311 and a lower end 312 of the long strip 31 are disposed with pins respectively while the pins are inserted into the electrical socket 151 on the bottom end of the receiving member 15 and an electrical socket 41 on a top end of the mounting member 40. Thus the lighting unit 30 is fixed easily between the receiving member 15 and the mounting member 40. The lighting unit 30 is also electrically connected between the receiving member 15 and the mounting member 40 so as to get power.

The mounting member 40, the gear set 50, and the motor 60 are arranged at the space in the first cap 12. The motor 60 drives the gear set 50 to rotate through an output shaft such as a worm shaft 61. The gear set 50 is formed by a plurality of gears driven by each other. By the speed-changing operation of the gear set 5, an output gear 51 is run at the speed the user requires.

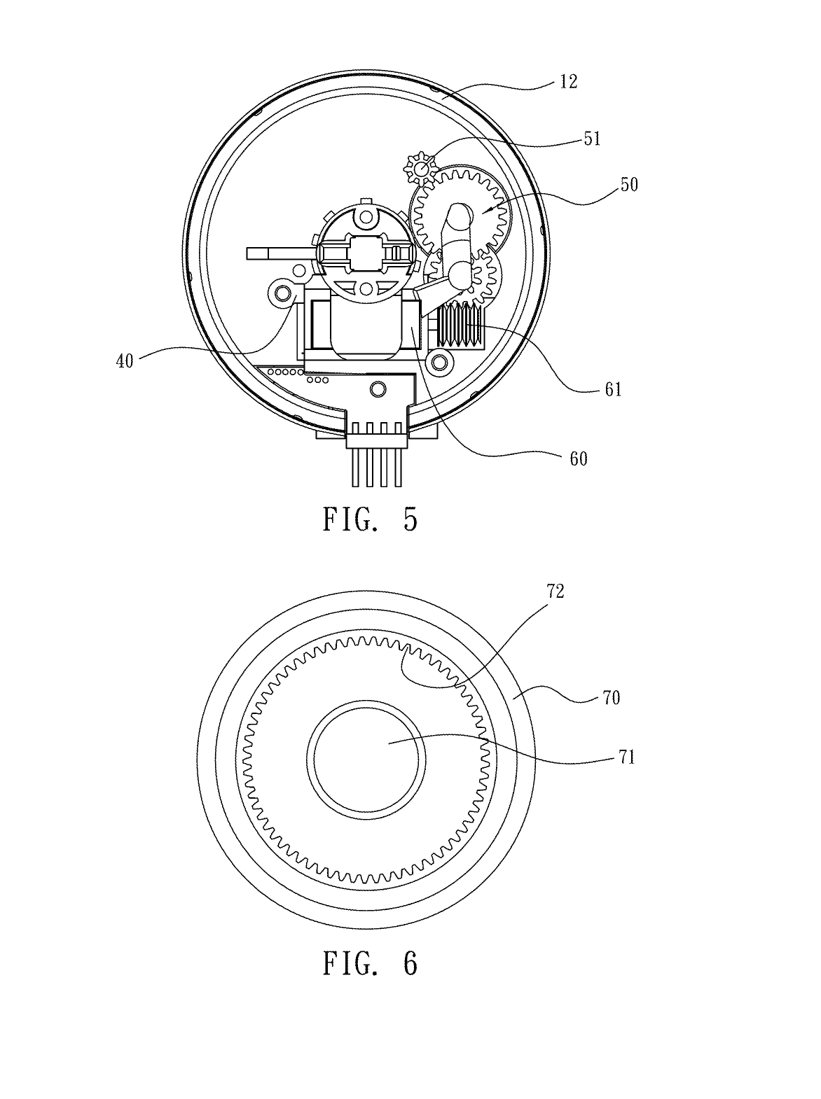

The rotary disc 70 is set over the first cap 12 or the mounting member 40. The rotary disc 70 consists of a central hole 71, a plurality of inner teeth 72, an outer edge surface 73, and a bottom edge 74. The electrical socket 41 on the top end of the mounting member 40 is passed through the central hole 71 so that the pins on the lower end 312 of the long strip 31 are inserted into the electrical socket 41. The inner teeth 72 for engagement of the output gear 51 of the gear set 50 is arranged circularly on the bottom surface of the rotary disc 70, as shown in FIG. 5 and FIG. 6. Thus the rotary disc 70 is driven by the output gear 51 to rotate smoothly over the upper outer-edge surface 122 of the first cap 12. By the design or control of the circuit board unit 80, the user can preset rotation mode of the rotary disc 70 such as clockwise rotation, counterclockwise rotation or rotation in different speeds.

The pattern layer set 90 includes an outer pattern layer 91 and an inner pattern layer 92 whose diameter is a bit smaller than that of the outer pattern layer 91. Both pattern layer set 90 can be, but not limited to, made from film with certain toughness. In this embodiment, both the outer pattern layer 91 and the inner pattern layer 92 are cylindrical tubes. While being assembled, the outer pattern layer 91 is firmly attached to an inner surface of the outer sleeve 14 by the tension itself and is kept still. A bottom end 921 of the inner pattern layer 92 is arranged at the outer edge surface 73 of the rotary disc 70 for being rotated along with the rotary disc 70. A diameter of the outer edge surface 73 is a bit smaller than that of the bottom edge 74, as shown in FIG. 4. Thus the inner pattern layer 92 is close to the outer pattern layer 91, but not in contact with the outer pattern layer 91, while rotated along with the rotary disc 70. There is a certain distance between the inner and the outer pattern layers 92, 91 and the inner and the outer pattern layers 92, 91 are moved in relation to each other stably.

The surface of the outer pattern layer 91 and the surface of the inner pattern layer 92 are set with an inner pattern and an outer pattern used in combination with each other and matched each other well. The patterns are designed according to user's requirements. The patterns preferred on the surface of the outer pattern layer 91 and the inner pattern layer 92 show the effect of persistence of vision (visual staying phenomenon) such as animation. When the inner pattern layer 92 is controlled to rotate clockwise or counterclockwise, light emitted from the light emitting elements 32 firstly passes through the pattern on the rotated inner pattern layer 92 and the pattern on the steady inner pattern layer 92, then to be projected to the translucent outer sleeve 14. Thus expected dynamic patterns are shown on a surface of the translucent outer sleeve 14.

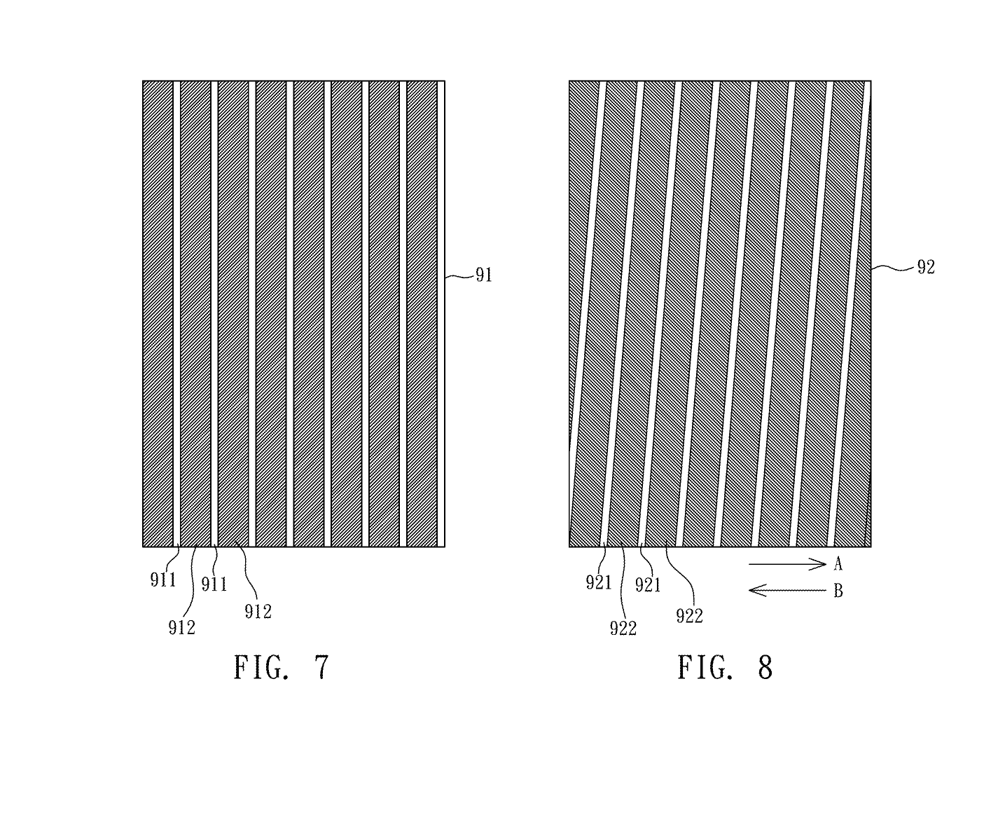

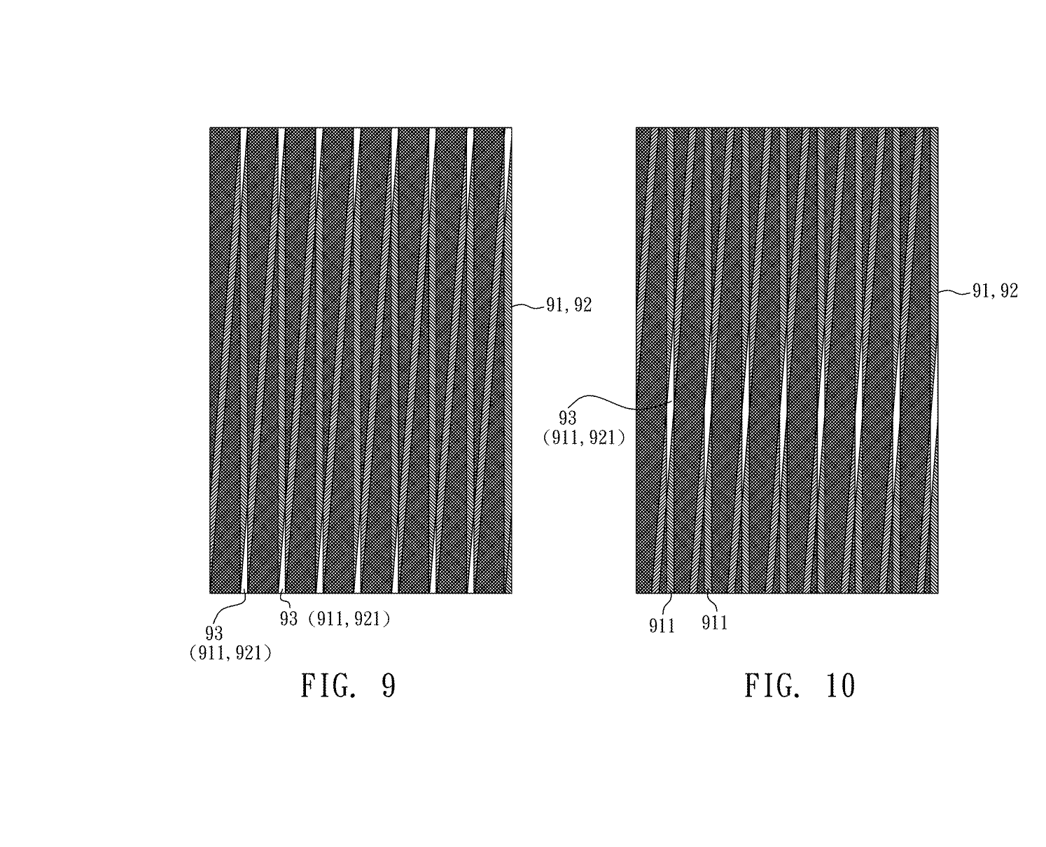

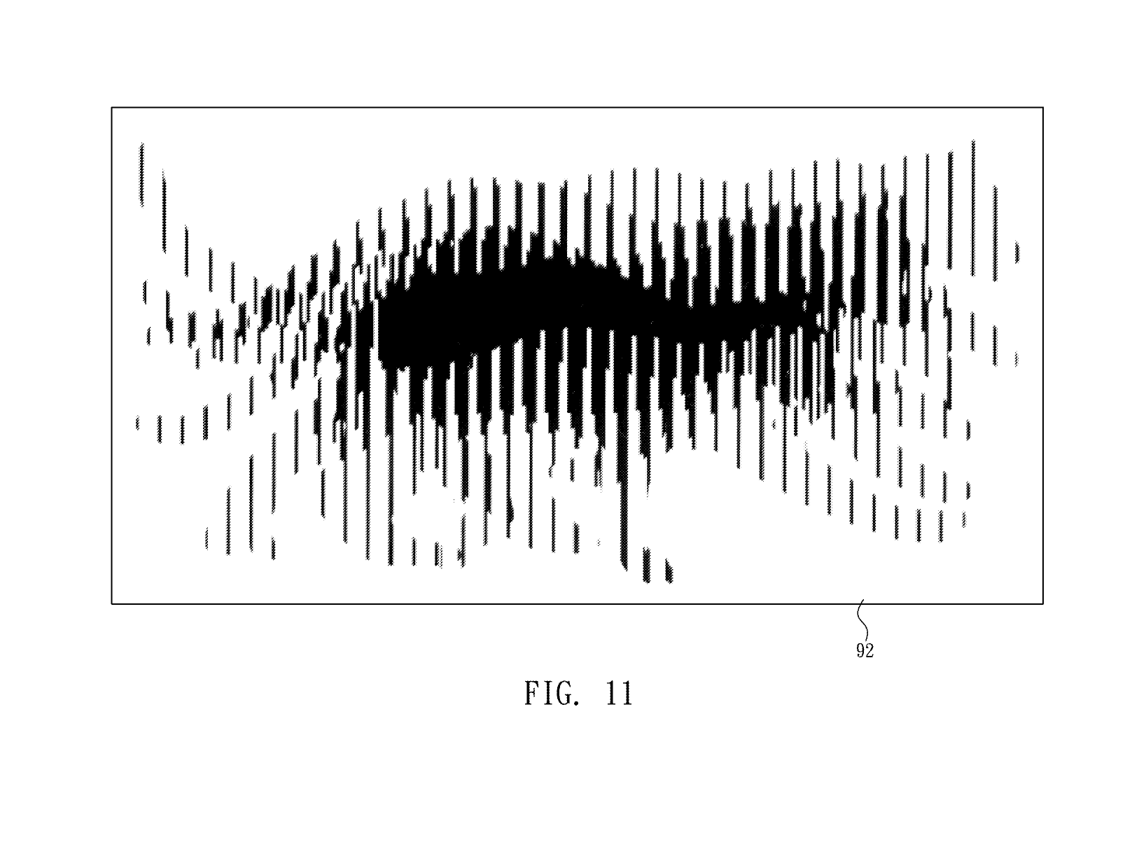

There are many patterns with the effect of persistence of vision/visual staying phenomenon available now. Please refer from FIG. 7 to FIG. 10, the surface of the outer pattern layer 91 and the inner pattern layer 92 is a flat surface. A plurality of straight transparent area 911 with an equal interval is disposed on the surface of the outer pattern layer 91. That means an opaque area (or sheltered area) 912 and the straight transparent area 911 are arranged alternately while each opaque area 912 has the same width and so does the straight transparent area 911, as shown in FIG. 7. Refer to FIG. 8, a plurality of oblique transparent area 921 with an equal interval is disposed on the surface of the inner pattern layer 92. That means an oblique opaque area (or sheltered area) 922 and the oblique transparent area 921 are arranged alternately while each oblique opaque area 922 has the same width and so does the oblique transparent area 921. As the arrow B in FIG. 8 indicated, light emitted from the light emitting element 32 firstly passes through the rotated oblique transparent area 921, the still straight transparent area 911 and then to be projected and displayed on the transparent outer sleeve 14 when the inner pattern layer 92 is driven to rotate clockwise. Thus a plurality of light area 93 is formed as shown in FIG. 9. The light area 93 is formed by a part of the light emitted from the light emitting element 32 passed through overlapped area of the straight transparent area 911 and the oblique transparent area 921 at specific time. Refer to FIG. 10, the light area 93 at the same the straight transparent area 911 in FIG. 9 is moved upward along with the slope of the oblique transparent area 921 when the oblique transparent area 921 of the inner pattern layer 92 is driven to rotate clockwise continuingly. For example, the light area 93 (911, 921) is moved from a lower part of the same straight transparent area 911 shown in FIG. 9, to a middle part of the same straight transparent area 911 shown in FIG. 10. A plurality of stripes of dynamic rising shooting-star-like light patterns is formed on the surface of the outer sleeve 14 due to persistence of vision. On the other hand, as the arrow A in FIG. 8 indicated, a plurality stripes of dynamic falling shooting-star-like light patterns is formed on the surface of the outer sleeve 14 when the inner pattern layer 92 is driven to rotate counterclockwise.

Moreover, the inner pattern layer 92 can also be arranged with other pattern having the effect of persistence of vision. For example, a pattern on an inner layer of an animation apparatus that produces animation via the persistence of vision phenomenon is shown in FIG. 11. The animation is displayed on the outer sleeve 14 by the light passed through the straight transparent area 911 of the outer pattern layer 91 when the inner pattern layer 92 is rotated.

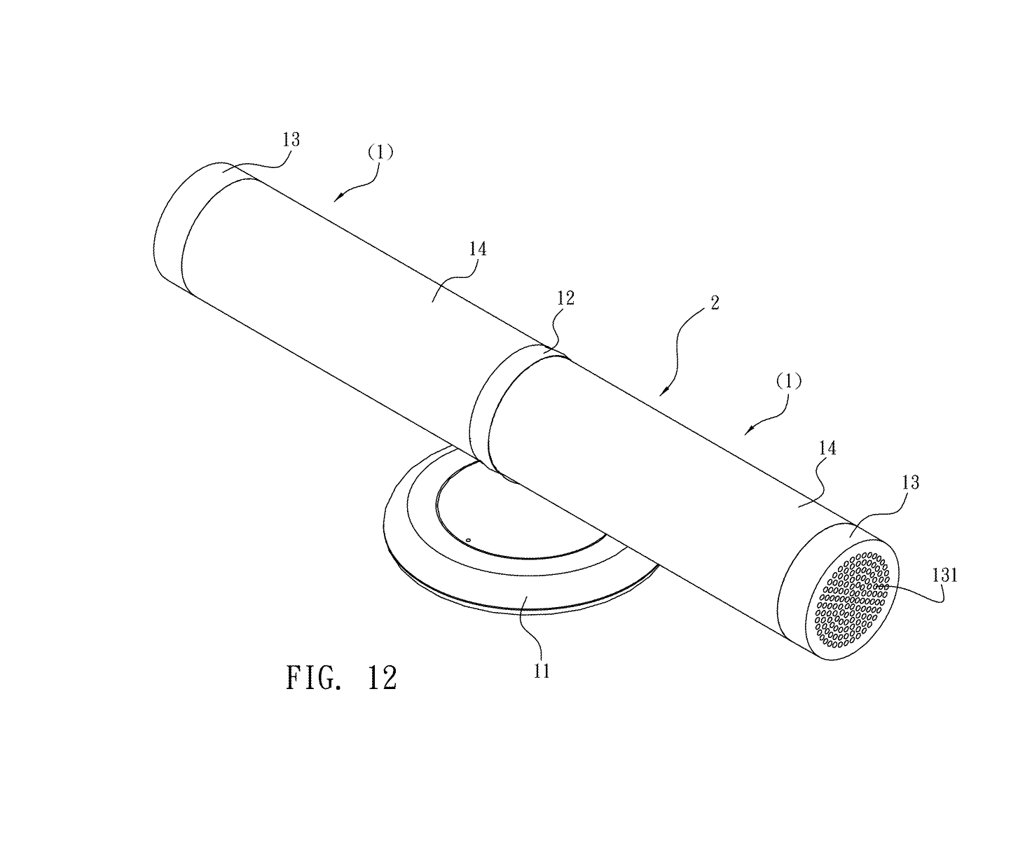

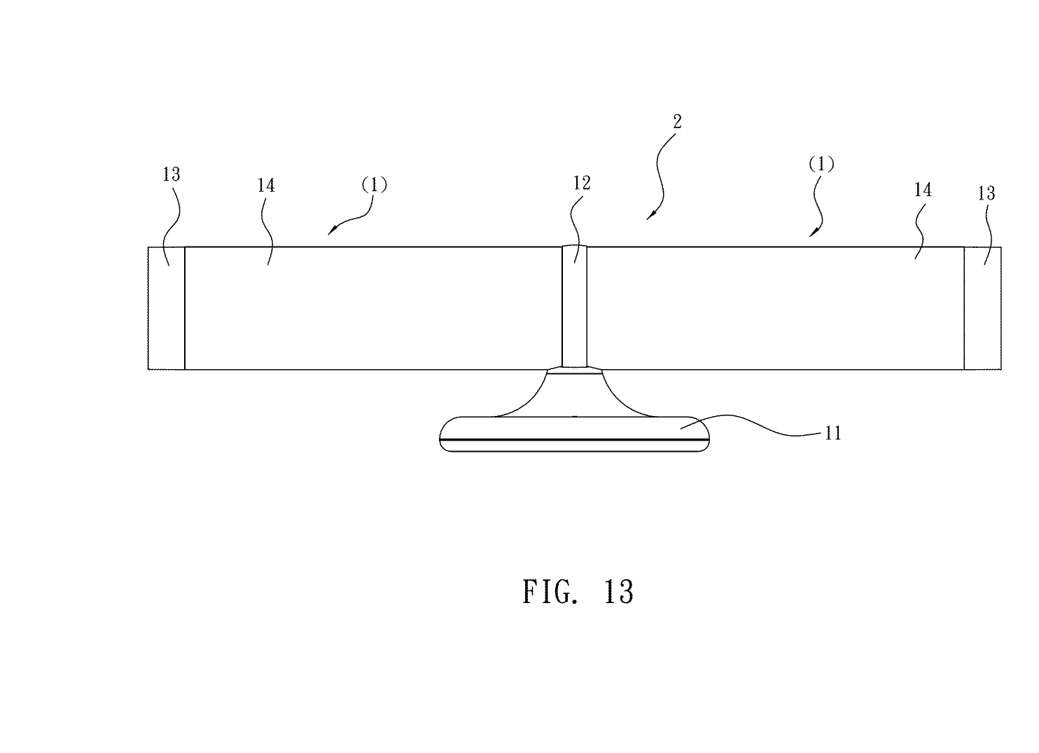

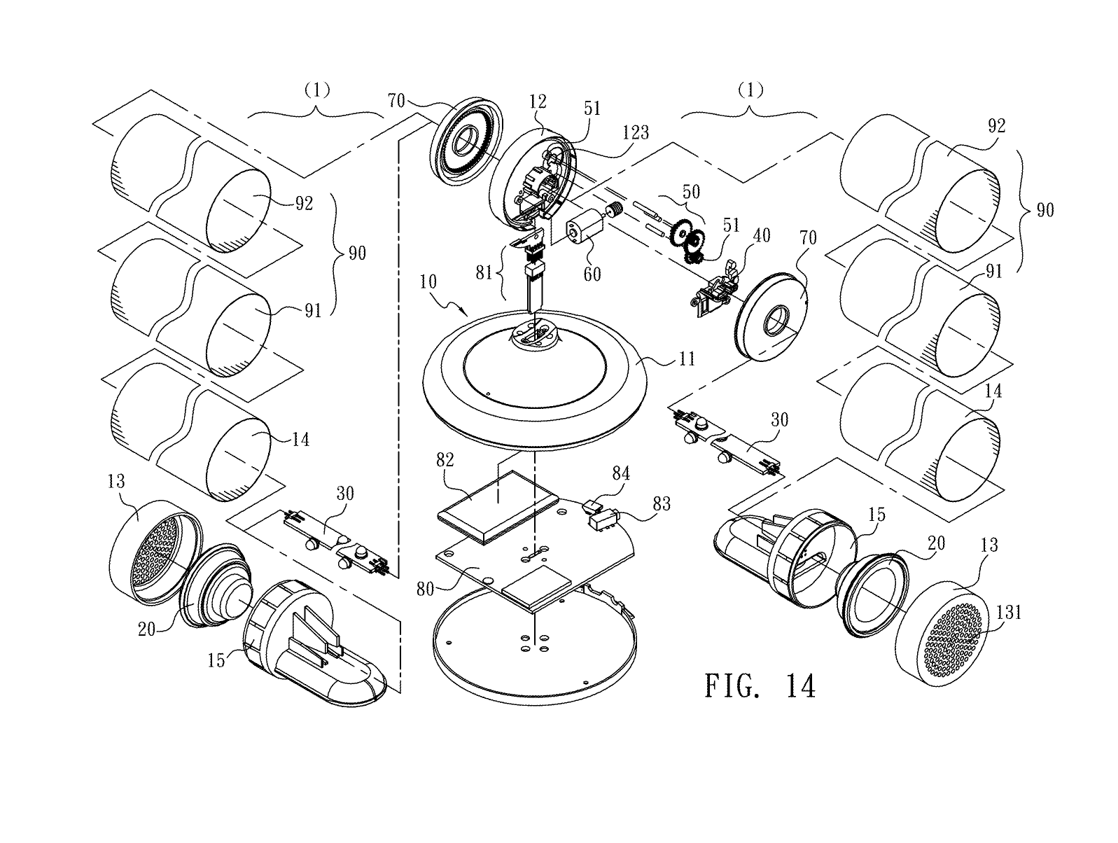

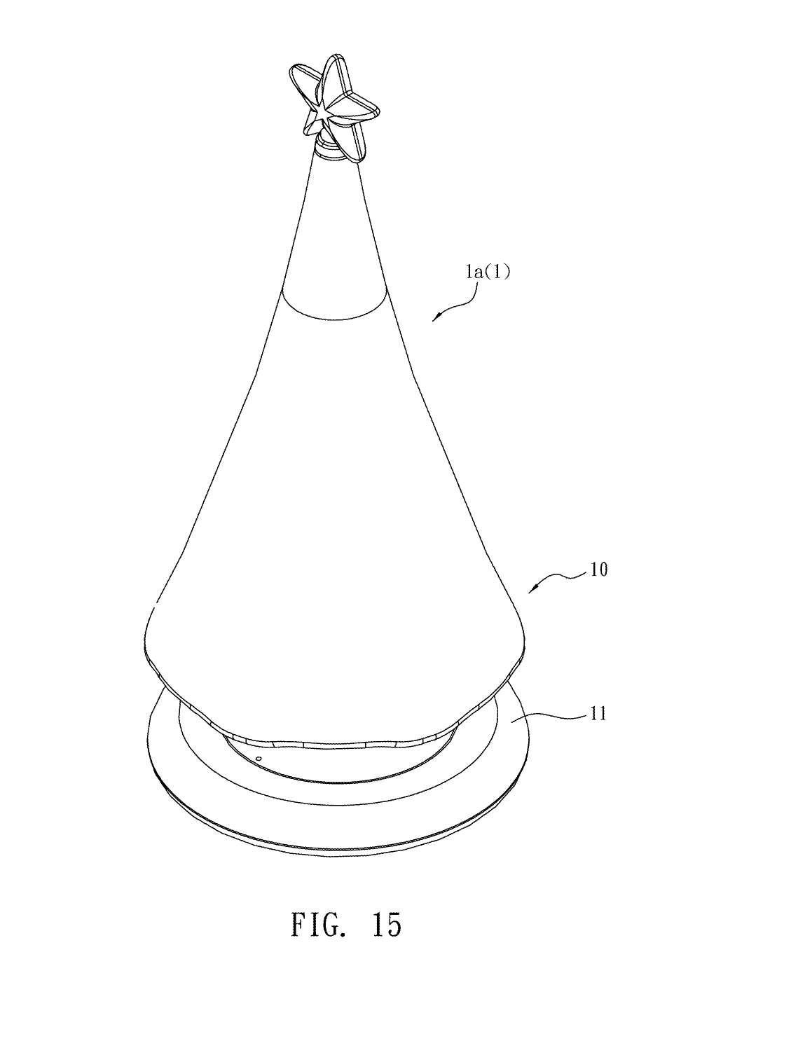

Refer to FIG. 12, FIG. 13, and FIG. 14, another embodiment is revealed. The second embodiment is a horizontal cylindrical light 2. This embodiment has the same technical features (such as used as a speaker cabinet) as the above embodiment. The difference between this embodiment and the one shown in FIG. 1 to FIG. 6 is in that this embodiment includes two vertical cylindrical lights I connected to each other and arranged horizontally. For simplifying structure and reducing cost, a part of components of the vertical cylindrical lights (1) on the left side and the right side respectively can use the same one component. For example, the horizontal cylindrical light 2 includes a base 11, a first cap 12, two second caps 13, two outer sleeves 14, two receiving members 15, two audio units 20, two lighting units 30, a mounting member 40, a gear set 50 with two output gears 51, a motor 60, two rotary discs 70, a circuit board unit 80 and two cylindrical pattern layer sets 90 (having two outer pattern layers 91 and two inner pattern layers 92). The base 11 and the first cap 12 are used for mounting the circuit board unit 80, a power supply unit 82, a power port 83 or a control port 84. The two vertical cylindrical lights (1) use the same gear set 50 and the same motor 60. The two output gears 61 driven by the same gear set 50 are disposed on the left side and the right side of the first cap 12 respectively for being engaged with inner teeth 72 on the bottom surface of each of the rotary discs 70. While in use, dynamic light patterns are also shown on an outer surface of the outer sleeve 14 of the two vertical cylindrical lights 1 on the left side and the right side of the horizontal cylindrical light 2 respectively, as the above embodiment.

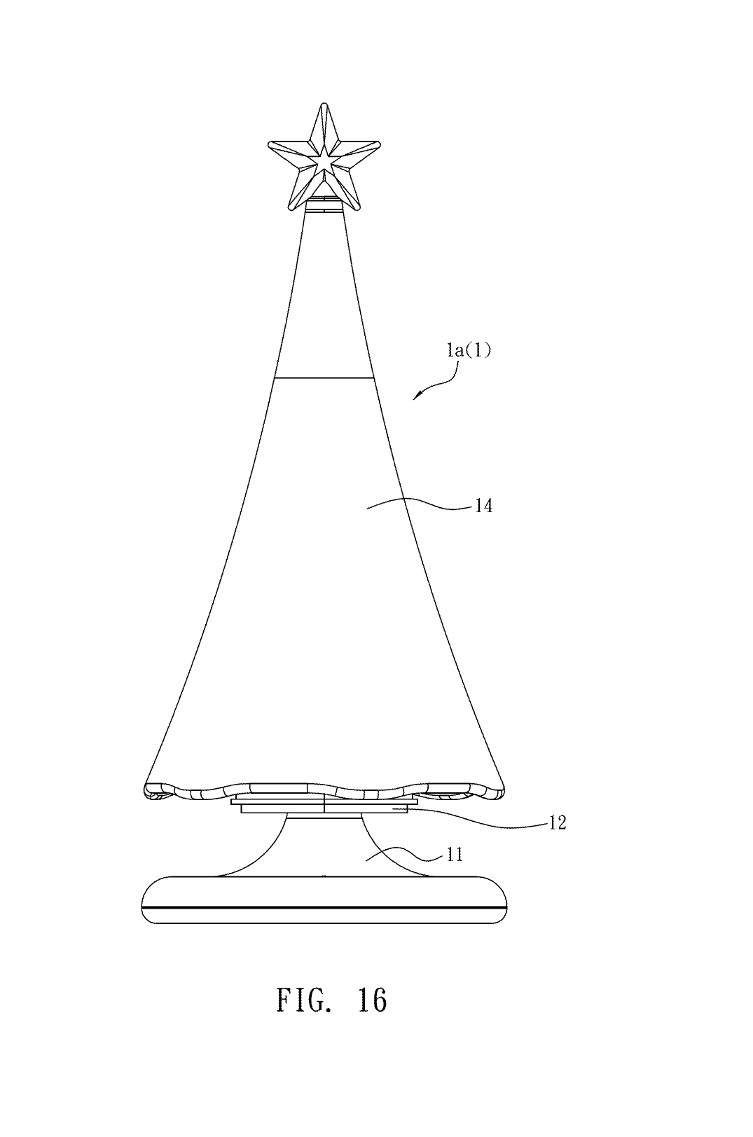

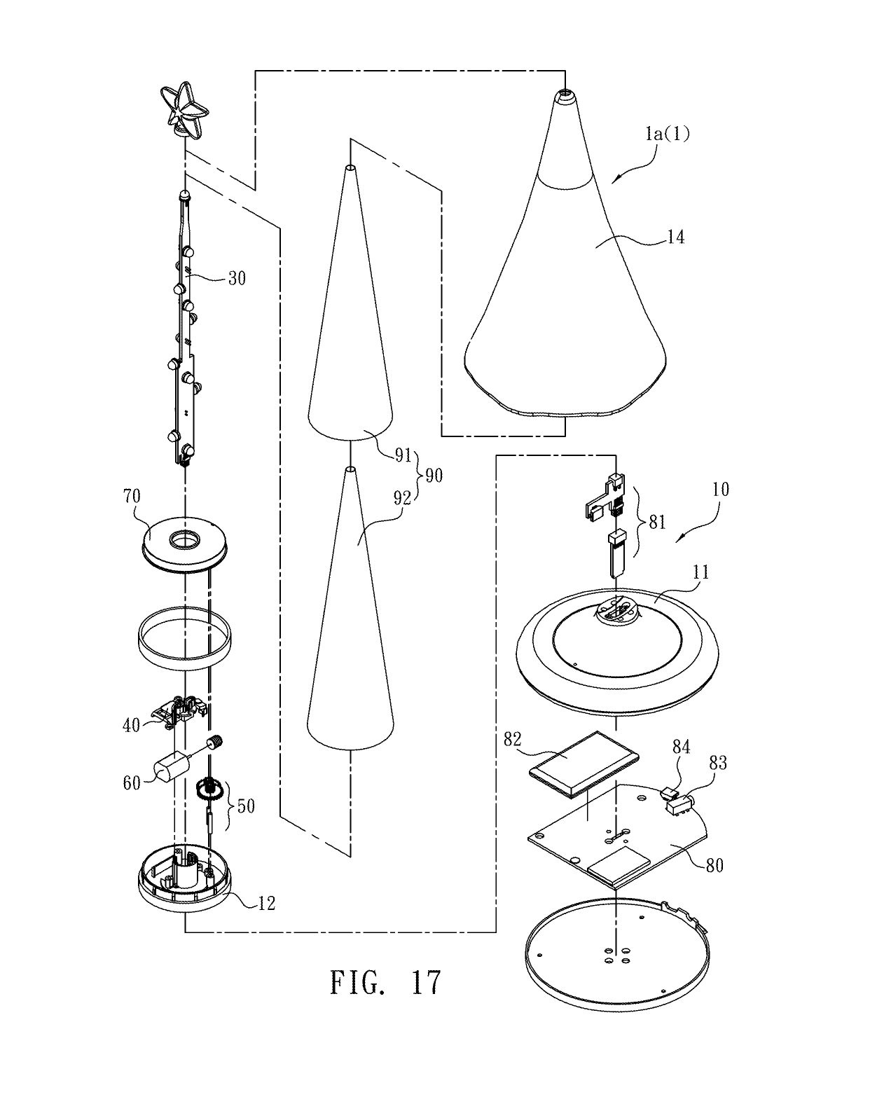

Refer to FIG. 15, FIG. 16, and FIG. 17, a further embodiment is disclosed. This embodiment is a vertical conical light 1a. Similar to the embodiment one, the vertical conical light 1a includes a housing 10, a lighting unit 30, a mounting member 40, a gear set 50, a motor 60, a rotary disc 70, a circuit board unit 80 and a cylindrical pattern layer set 90. The difference between this embodiment and the above one shown in FIG. 1 to FIG. 6 is in that the vertical conical light 1a is not disposed with the audio unit 20 and is unable to be used as a speaker cabinet. Moreover, in the housing 10, this embodiment keeps the base 11, the first cap 12, and the outer sleeve 14 while the second cap 13 and the receiving member 15 are removed. The outer sleeve 14, the pattern layer set 90, the outer pattern layer 91 and an inner pattern layer 92 are all conical. While in use, the inner pattern layer 92 is controlled to rotate clockwise or counterclockwise. Light emitted from the lighting unit 30 firstly passes through the rotated inner pattern layer 92 and the steady outer pattern layer 91 to be projected to the translucent outer sleeve 14 so as to form the expected dynamic pattern around a surface of the outer sleeve 14.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light with dynamic light patterns comprising:
a housing having a base, a first cap connected to the base;
an audio unit that makes sounds to be played through a plurality of through holes;
a lighting unit set over the first cap and having a long strip that is disposed with circuit and a plurality of light emitting elements for emitting light out;
a gear set arranged over the first cap and having a plurality of gears and an output gear;
a motor disposed over the first cap and used for driving the gear set to rotate;
a rotary disc set over the first cap and driven by the output gear to rotate;
a circuit board unit disposed in the base and electrically connected to both the motor and the lighting unit for control of rotation of the motor and lighting of the lighting unit; and
a pattern layer set arranged over the first cap and having a still outer pattern layer and an inner pattern layer with a diameter smaller than a diameter of the outer pattern layer; the inner pattern layer being disposed on the rotary disc and rotated along with the rotary disc, without in contact with the outer pattern layer; the inner pattern layer and the outer pattern layer are moved in relation to each other stably with a certain distance therebetween;
wherein the inner pattern layer and the outer pattern layer are arranged with patterns that match each other well respectively; light emitted from the light emitting elements firstly passes the pattern of the inner pattern layer and then the pattern of the still outer pattern layer to be projected out and forming a dynamic light pattern according to the patterns of the inner pattern layer and the outer pattern layer that match each other well when the inner pattern layer is driven to rotate clockwise or counterclockwise.

2. The light as claimed in claim 1, wherein the housing further includes an outer sleeve fitted around the outer pattern layer; thus the light emitted from the light emitting elements is projected on the outer sleeve and the dynamic light pattern according to the patterns of the inner pattern layer and the outer pattern layer that match each other well is formed on a surface of the outer sleeve.

3. The light as claimed in claim 2, wherein a shape of the outer pattern layer, the inner pattern layer and the outer sleeve is cylindrical or conical.

4. The light as claimed in claim 1, wherein the housing further includes a second cap disposed on an opposite end of the first cap; an audio unit is disposed on an inner side of the second cap so that the sounds from the audio unit are played through the through holes arranged at the second cap.

5. The light as claimed in claim 4, wherein a mounting member and a receiving member are disposed between the first cap and the second cap; wherein an upper end and a lower end of the long strip are disposed with pins respectively while the pins are inserted into an electrical socket on one end of the receiving member and an electrical socket on one end of the mounting member respectively so that the lighting unit is fixed between and electrically connected to the receiving member and the mounting member.

6. The light as claimed in claim 1, wherein the rotary disc includes a central hole and a plurality of inner teeth arranged circularly on a bottom surface of the rotary disc; the inner teeth are engaged with the output gear of the gear set so that the rotary disc is driven by the output gear to rotate.

7. The light as claimed in claim 2, wherein the patterns of the inner pattern layer and the outer pattern layer that match each other well are patterns with effect of persistence of vision; thus the light emitted from the light emitting elements firstly passes the pattern of the inner pattern layer and then the pattern of the still outer pattern layer to be projected on the outer sleeve and forming the dynamic light pattern with the effect of persistence of vision when the inner pattern layer is driven to rotate clockwise or counterclockwise.

8. The light as claimed in claim 7, wherein the patterns with effect of persistence of vision include a plurality of straight transparent area with an equal interval is disposed on a surface of the outer pattern layer while a plurality of oblique transparent area with an equal interval is disposed on a surface of the inner pattern layer; the light emitted from the light emitting element firstly passes through the rotated oblique transparent area and the still straight transparent area then to be projected to the outer sleeve and a plurality of light area is formed on the outer sleeve when the inner pattern layer is driven to rotate clockwise or counterclockwise; the light area is formed by a part of the light emitted from the light emitting element passed through overlapped area of the straight transparent area and the oblique transparent area at specific time; the light area at the same the straight transparent area is moved upward or downward along with a slope of the oblique transparent area so as to form a plurality of stripes of dynamic rising or falling shooting-star-like light patterns on a surface of the outer sleeve due to persistence of vision when the oblique transparent area of the inner pattern layer is driven to rotate clockwise continuingly.

9. The light as claimed in claim 1, wherein the light is selected from the group consisting of a vertical cylindrical light, a horizontal cylindrical light and a vertical conical light.
